(19) United States
(12) Patent Application Publication
(10) Pub. No.: US 2007/0033276 A1
(43) Pub. Date: Feb. 8, 2007

(54) Application portfolio and architecture research tool

(75) Inventors: Paula Brockhoff, Snellville, GA (US); Brenton Westwood, Pelham, AL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Southern Company Services, Inc.

(21) Appl. No.: 11/199,000

(22) Filed: Aug. 8, 2005

(51) Int. Cl. G06F 15/173

(52) U.S. Cl. 709/224; 707/3

(57) ABSTRACT

A method and computer program product are provided for automatically managing and coordinating information and changes relating to an information technology infrastructure. The information and changes are stored in an application portfolio database. Information for a plurality of applications and a plurality of servers is determined and stored in the application portfolio database. The application information includes application version identification and status for each application; the server information includes server identification, status and a call group for each server. Information for call groups associated with the servers and applications is determined and stored. Information regarding the components for each version of an application is determined and stored. Application dependencies for each application are determined and stored. A plurality of applications associated with each server is identified. An impact analysis in the event of server failure is determined for each application running on each server. An impact analysis display provides a link to application dependencies and the call group associated with the failed server.

### BACKGROUND OF THE INVENTION

The present invention relates generally to managing information technology infrastructure and, more particularly, to managing a portfolio of applications and resources that define the infrastructure components used in a large business enterprise and the relationships between the components.

In the prior art, there are individual applications that are capable of providing information separately on servers, or applications, or call groups, or application testing or databases. For example, the Systems Management Server (SMS), available from Microsoft Corporation, provides information on servers and includes a change and configuration management solution for the Microsoft Windows platform, enabling organizations to provide software updates to users. Asset Insight is another automatic tracking and management product that can discover hardware, software, and configuration files on desktops, laptops, mainframes and network devices for various platforms including UNIX.

Software tools such as Clarify and PVCS, available from Amdocs, Ltd. and Serena Software, Inc. respectively, provide information on change management or source management for applications. However, such software tools are difficult to search for data and do not store all the relationship data that is stored on the applications by the present invention.

There are various applications that do call list scheduling and associate people and contacts with responsibility. However, these applications do not associate call lists with responsibility to applications, servers, and server groups.

There are also applications that store information on software applications and the performance of the applications under tests. However, there is no current way to associate the application under test to all the other applications that the application under test depends upon.

Nor is there any application that relates the application under test to the servers that it will be deployed to, or to the contacts and contact information for that application.

There is a need in the art for an automated method to create and maintain information on the applications that are developed by an Information Technology (IT) organization and supported for the business units of a large organization. The method should contain data about the application and infrastructure components, its business function, its criticality to the business. The method should also provide a list of technology used for implementation , the users and support personnel.

### SUMMARY OF THE INVENTION

The present invention is directed to a method and program product for managing and coordinating information and changes to the IT infrastructure. The Application Portfolio and Architecture Research Tool (APART) integrates most of the sources on application information and server information into an easily accessible, robust tool. APART is a web-based application that maps out a company's IT architecture with regard to applications, servers, and databases. More specifically, APART provides a library of information on the applications and servers used within a company. It is the main tool for contact information on applications, servers, and other infrastructure support areas used by the IT help desk and infrastructure management center of the company. This library of information on who supports applications, servers and other infrastructure areas or groups is referred to as “call groups” in the invention. The tool is also used for validating the high disaster recovery priority applications (i.e., applications needing to be recovered within 24-72 hours). The disaster recovery applications are identified and checked so that all required information has been entered to allow someone to install the application at a disaster recovery site. The tool also records Product Certification and Delivery (PC&D) certifications and deliveries of applications and software being deployed in the company's infrastructure. In summary, APART can be used as a search engine for finding information on applications, releases of applications, names of support personnel for an application, servers, names of personnel who support a server, server leases, product deployments, secure socket layer (SSL) expirations, and call groups.

The present invention can be used by application portfolio managers to provide current information on the suite of applications supported by their groups to plan for upgrades and replacements. The invention provides a record of server locations for each application, data base, etc. and would be beneficial in determining impacted system and clients during server outages.

In one aspect of the invention, a method is provided for automatically managing and coordinating information and changes relating to an information technology infrastructure. The information and changes are stored in an application portfolio database. The method includes determining and storing information for a plurality of applications and a plurality of servers wherein the application information includes application version identification and status for each application, and the server information includes server identification, status and a call group for each server; determining and storing information for a plurality of call groups, wherein each call group defines a call list of contacts; determining and storing information for a plurality of components for each version of an application; determining and storing a plurality of application dependencies for each application; identifying a plurality of applications associated with each server; and determining an impact analysis in the event of server failure for each application running on each server, wherein an impact analysis display provides a link to application dependencies and the call group associated with the server.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates processing logic for adding information for a new application into the APART system in an exemplary embodiment of the present invention.

FIG. 2 illustrates a user interface for an application search in the APART system in an exemplary embodiment of the present invention.

FIG. 3 illustrates a user interface for entering an application name in a search window in the APART system in an exemplary embodiment of the present invention.

FIG. 4 illustrates an application search results display in the APART system in an exemplary embodiment of the present invention.

FIG. 5 illustrates application general information display in an exemplary embodiment of the present invention.

FIG. 6 illustrates an application versions display in an exemplary embodiment of the present invention.

FIG. 7 illustrates a version general information display in an exemplary embodiment of the present invention.

FIG. 8 illustrates an application version servers display in an exemplary embodiment of the present invention.

FIG. 9 illustrates an application server general information window display in an exemplary embodiment of the present invention.

FIG. 10 illustrates an application call group display in an exemplary embodiment of the present invention.

FIG. 11 illustrates a general contact information display for a member of a call group in an exemplary embodiment of the present invention.

FIG. 12 illustrates an application client bases display in an exemplary embodiment of the present invention.

FIG. 13 illustrates an application notes display in an exemplary embodiment of the present invention.

FIG. 14 illustrates an application version components display in an exemplary embodiment of the present invention.

FIGS. 15A-15B illustrate an application dependency display in an exemplary embodiment of the present invention.

FIG. 16 illustrates a server search display in an exemplary embodiment of the present invention.

FIG. 17 illustrates a server other search options display in an exemplary embodiment of the present invention.

FIG. 18 illustrates a server search results display in an exemplary embodiment of the present invention.

FIG. 19 illustrates a server search general information display in an exemplary embodiment of the present invention.

FIGS. 20A-20B illustrate an auto discovered server information display in an exemplary embodiment of the present invention.

FIG. 21 illustrates a server search server groups display in an exemplary embodiment of the present invention.

FIG. 22 illustrates a server search applications display in an exemplary embodiment of the present invention.

FIG. 23 illustrates a server search outage impact analysis display in an exemplary embodiment of the present invention.

FIG. 24 illustrates a server search application types display in an exemplary embodiment of the present invention.

FIG. 25 illustrates an outage impact callout display in an exemplary embodiment of the present invention.

FIG. 26 illustrates an outage impact dependencies display in an exemplary embodiment of the present invention.

FIG. 27 illustrates a server search roles display in an exemplary embodiment of the present invention.

FIG. 28 illustrates a server search email display in an exemplary embodiment of the present invention.

FIG. 29 illustrates a contacts and call group display in an exemplary embodiment of the present invention.

FIG. 30 illustrates the high level processing logic for the APART system in an exemplary embodiment of the present invention.

### DETAILED DESCRIPTION OF THE INVENTION

The following description of the invention is provided as an enabling teaching of the invention and its best, currently known embodiment. Those skilled in the art will recognize that many changes can be made to the embodiments described while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations of the invention are possible and may even be desirable in certain circumstances and are part of the present invention. Thus, the following description is provided as illustrative of the principles of the invention and not in limitation thereof since the scope of the present invention is defined by the claims.

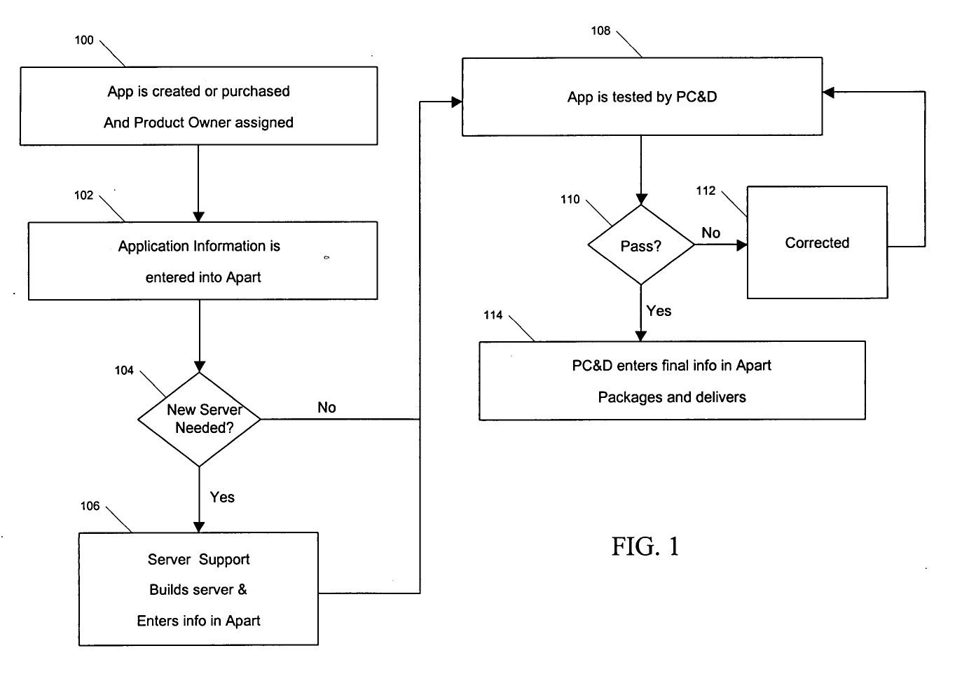

FIG. 1 illustrates processing logic for adding information for a new application into the APART system. In step 100, an application is created internally or is purchased from a software vendor. A product owner is assigned to the product within the IT organization. In step 102, information on the application is entered into the APART system. In step 104, a decision is made as to whether or not a new server is needed for the application. If the decision is that a new server is needed, then in step 106, server support builds the server and enters server information into APART. Following this step, or if a negative decision is made in step 104, the application is tested by a product certification and delivery organization in step 108. In step 110, a determination is made as to whether or not the application has passed the certification tests. If it ha snot, then corrections are made in step 112, followed by retesting in step 108. If the application passes the certification tests in step 110, then the product certification and delivery organization enters final information on the application into APART and packages and delivers the application in step 114.

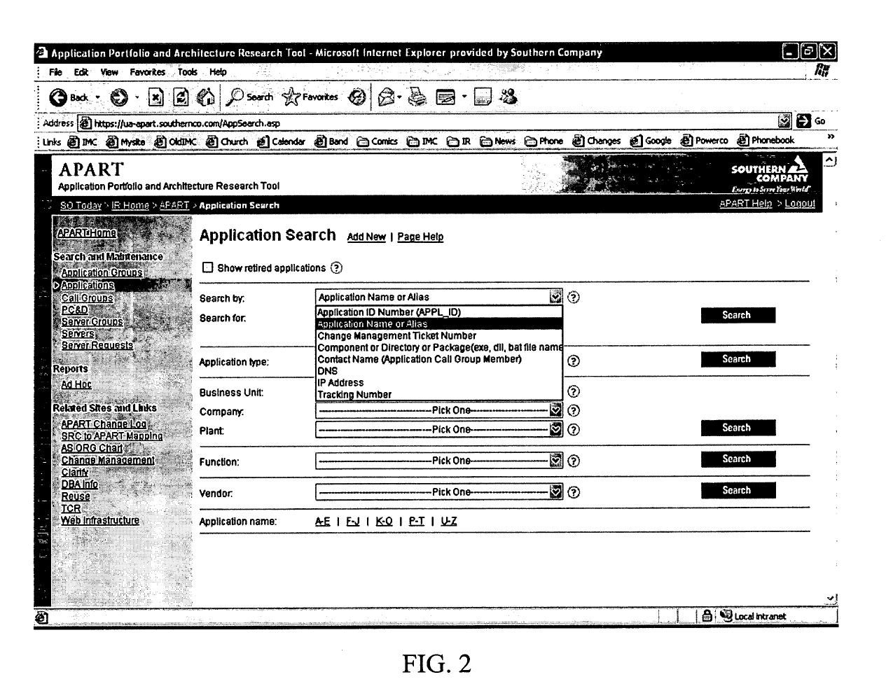

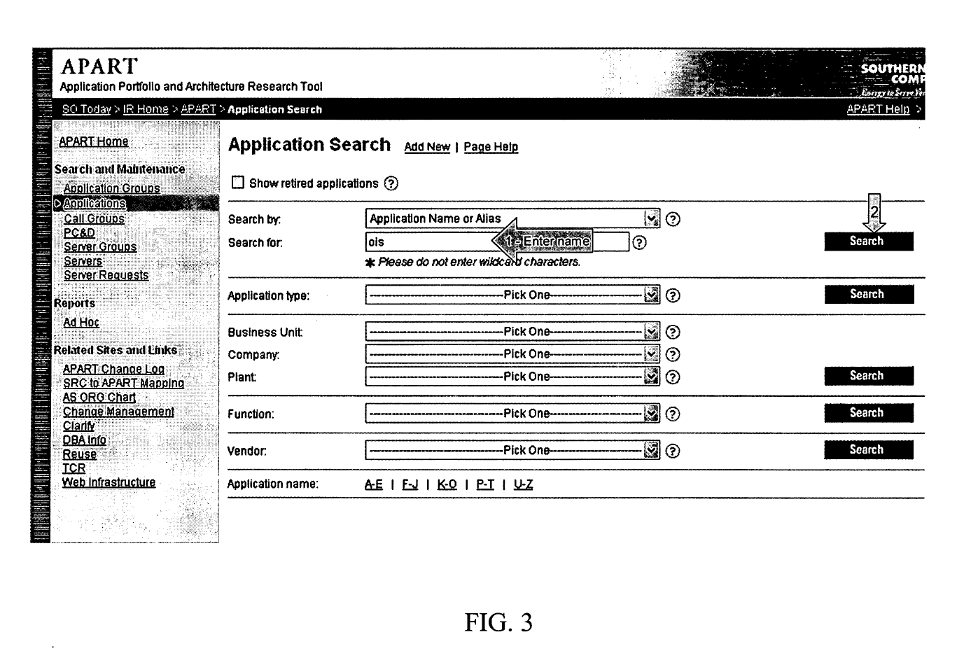

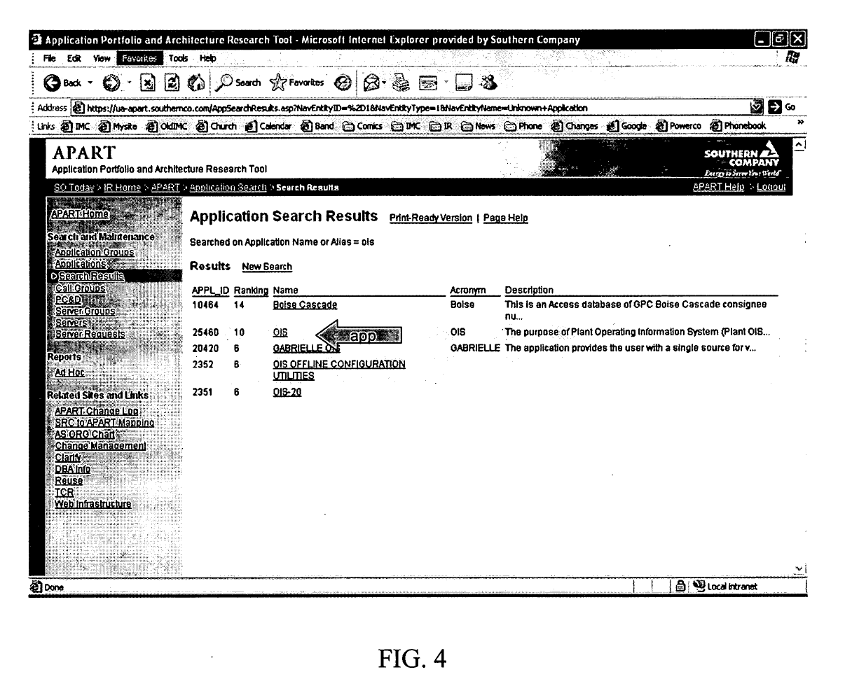

FIG. 2 illustrates a user interface for an application search in the APART system. The user selects “Applications” from the “Search and Maintenance” navigation toolbar on the left side of the display. The user can then select “Application Name or Alias” from the application search window shown in the main window in the figure. Other search options available in the search window include application ID number, change management ticket number, component or directory or package, contact name, Domain Name System (DNS), Internet Protocol (IP) address and tracking number. FIG. 3 illustrates a user interface for entering an application name in a search window. After entering an application name in the “search for” window, the use selects “Search” on the right side of the search window to initiate the search. FIG. 4 illustrates an application search results display. The search results include the application ID, search ranking, name, corresponding acronym, if any, and description of the results.

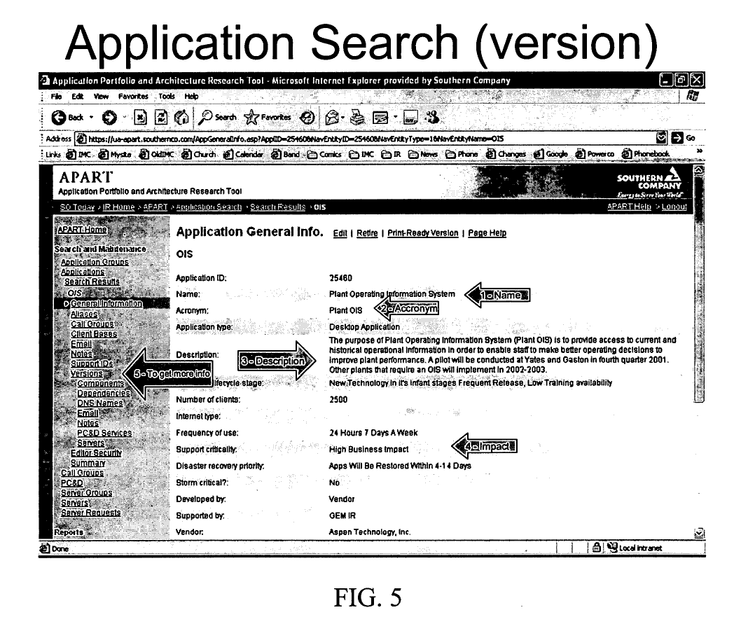

FIG. 5 illustrates an application general information display that is presented when the user selects an application on the application search results display of FIG. 4. The application general information display includes the application ID (e.g., 25460), application name (e.g., Plant Operating Information System), application acronym, application type and description. Other fields displayed include lifecycle stage, number of clients, Internet type, frequency of use, support criticality (e.g., high business impact), disaster recovery priority, developed by information, supported by information and vendor, if applicable. The Search and Maintenance navigation toolbar also expands in this display to enable the user to drill down into other information on the specific application.

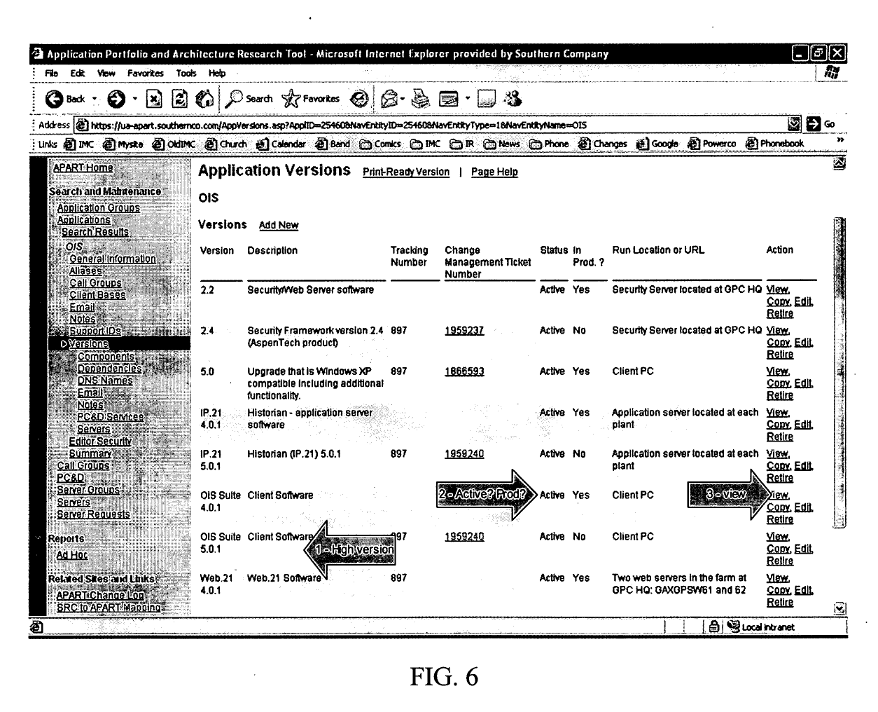

FIG. 6 illustrates an application versions display that is presented when the user selects “Versions” from the expanded navigation toolbar of FIG. 5. As depicted in this figure, the information for application versions includes version number, description, tracking number, changer management ticket number, version status (e.g., active), whether the version is in production, the run location or URL and version action links (e.g., view, copy, edit, retire).

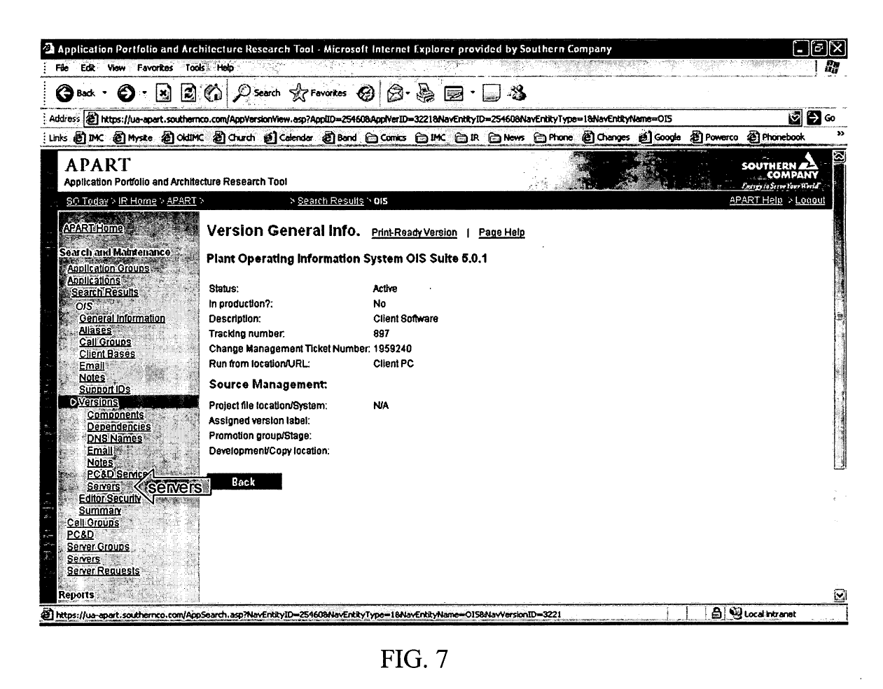

Selecting a view version action link in FIG. 6 results in the display of FIG. 7. As shown, certain status information is repeated from FIG. 6 and displayed along with source management information.

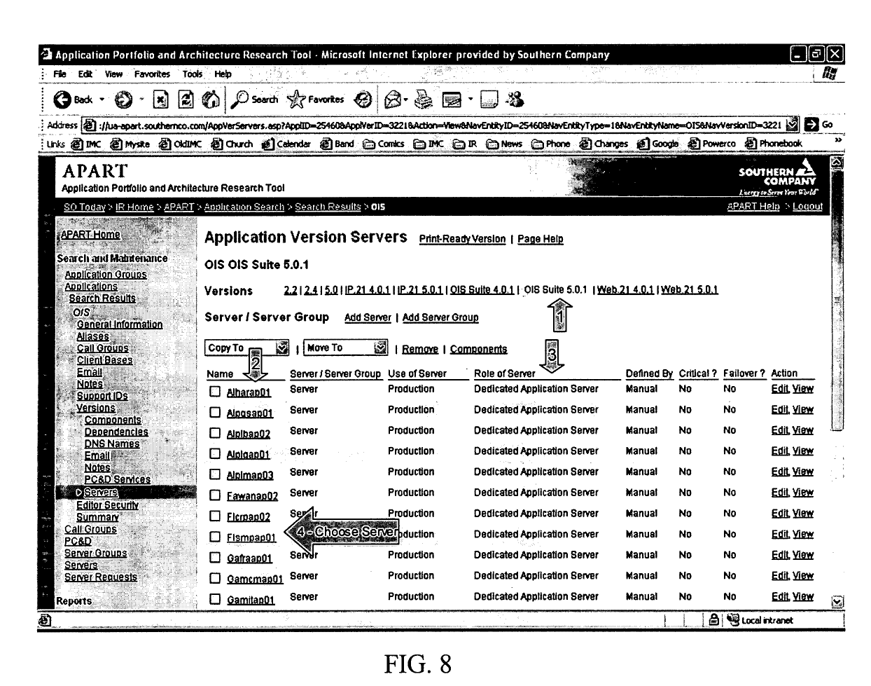

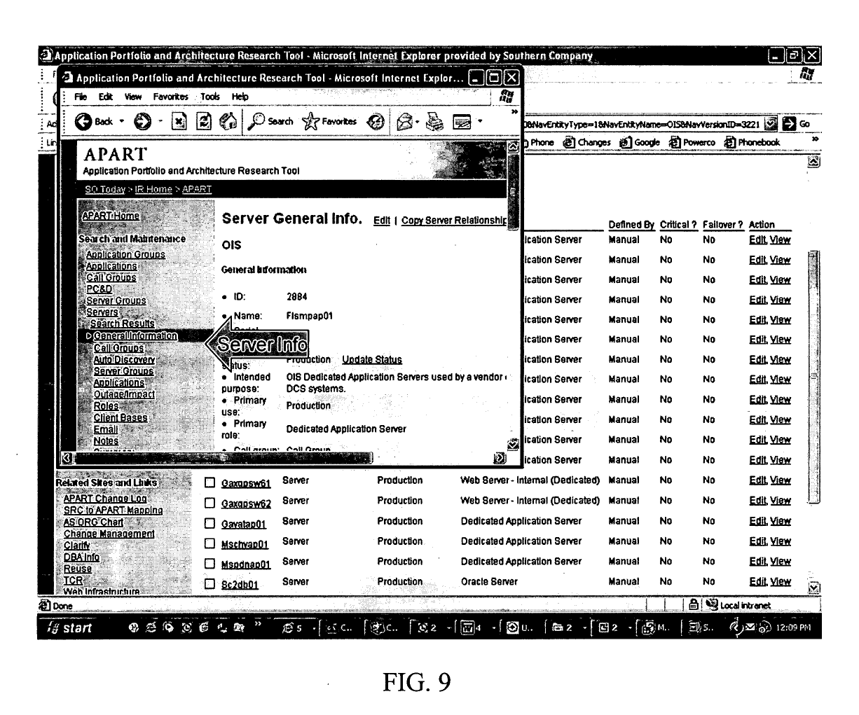

FIG. 8 illustrates an application version servers display that is presented when the user selects “Servers” from the expanded navigation toolbar of FIG. 7. The screen displays the servers associated with the particular application version selected in FIG. 6. The information shown includes server name, server group, use of server (e.g., production), role of server (e.g., dedicated application server), how server is defined (e.g., manually), whether the application server is critical and an action link (edit, view). By selecting a specific server in FIG. 8, the user is presented with the server general information window shown in FIG. 9.

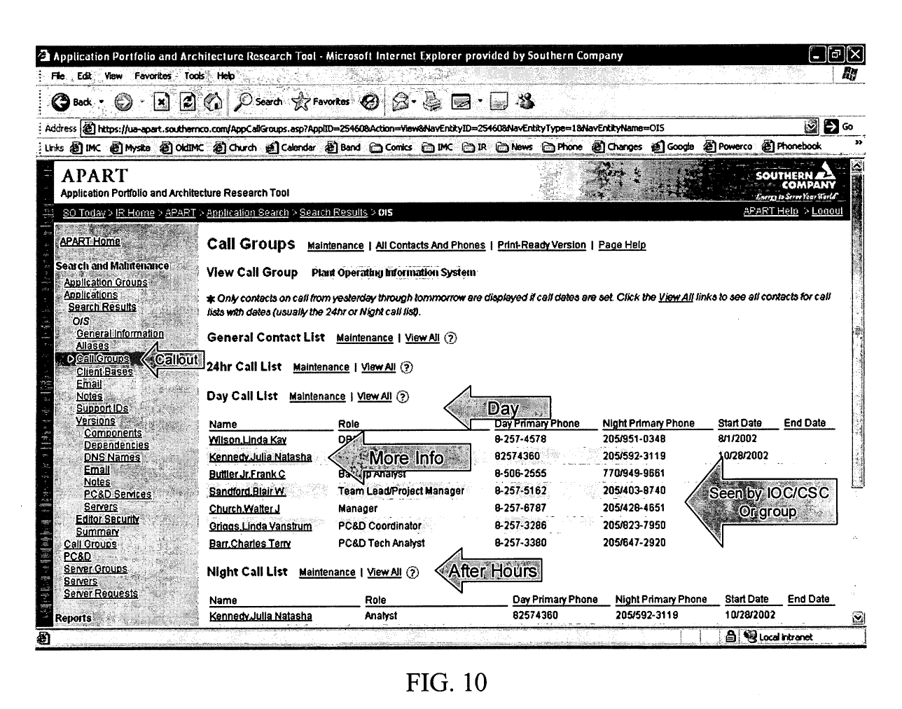

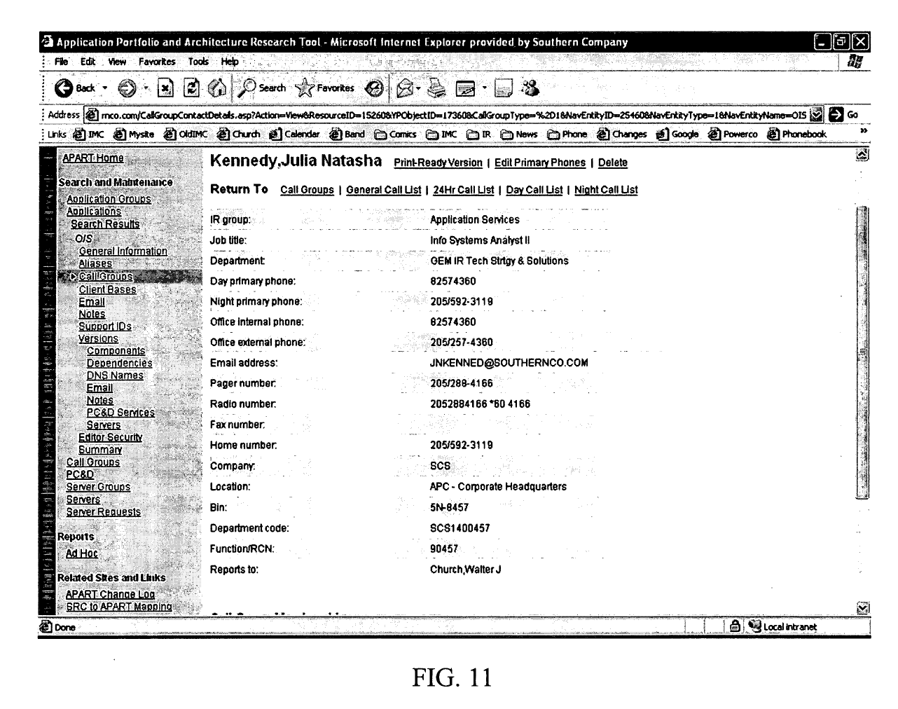

FIG. 10 illustrates an exemplary application call group display. This screen is presented by selecting “Call Groups” from the expanded “Search and Maintenance” navigation bar. The information available or presented on the screen includes general contact list, a 24-hour call list, a day call list and a night call list. Selecting a specific individual on the call lists displayed in this figure results in the exemplary display of FIG. 11.

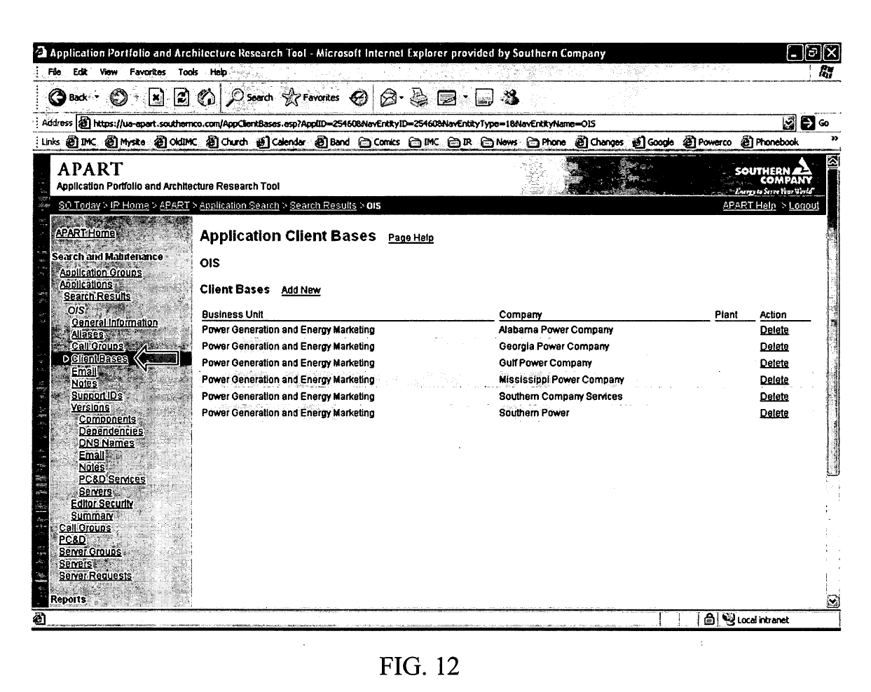

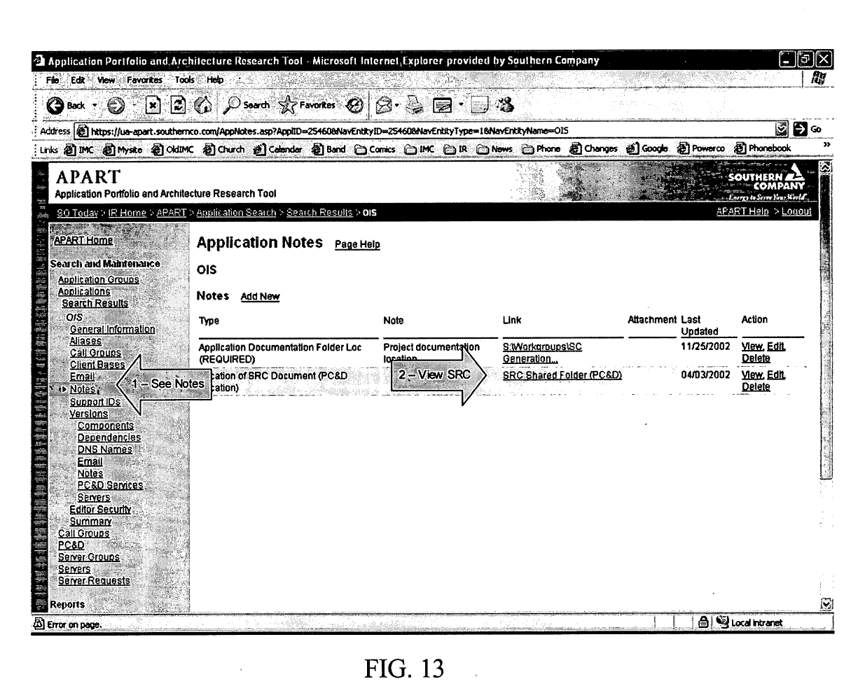

FIG. 12 illustrates an application client bases display that is presented by selecting “Client Bases” from the expanded “Search and Maintenance” navigation bar. For the specific application, the client bases display includes business unit, company, plant information and an action link (e.g., delete). FIG. 13 illustrates an application notes display that is presented by selecting “Notes” from the expanded “Search and Maintenance” navigation bar. The information provided by this display includes the type of application, a note concerning the application, a link to the note and an action link.

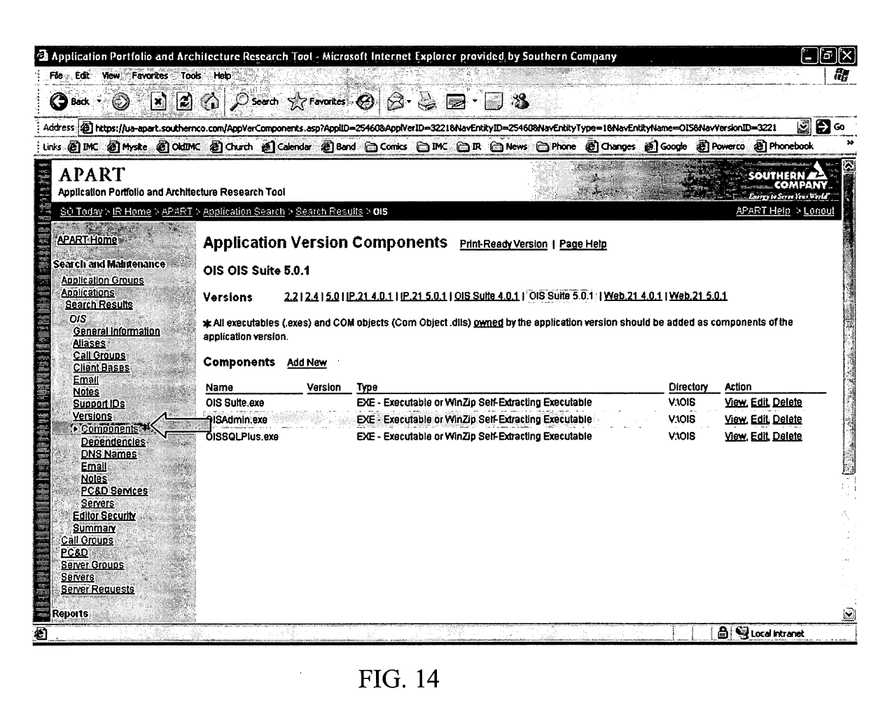

FIG. 14 illustrates an application version components display that is presented by selecting “Components” under “Versions” from the expanded “Search and Maintenance” navigation bar. All executables (.exe files) and COM objects (Com.Object.dll) that are owned by the application version should be added as components. As shown in the figure, the display includes the component names, component types, directory and an action link (view, edit, delete).

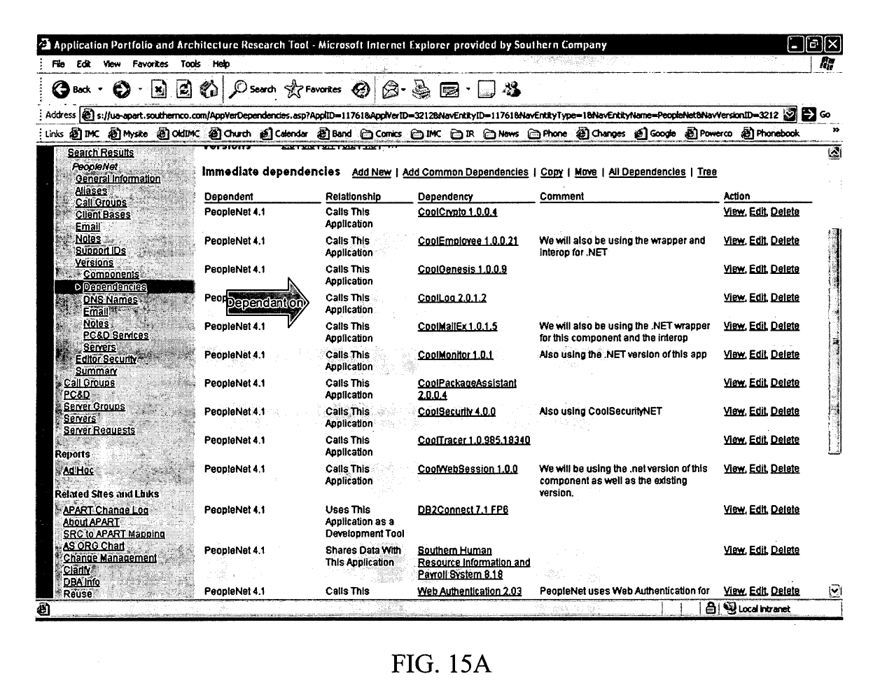

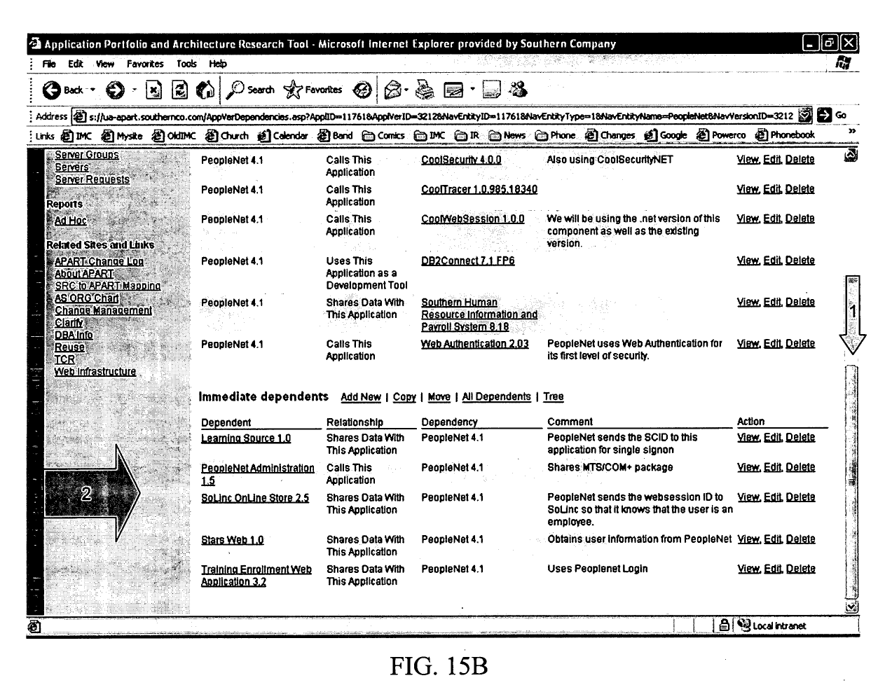

FIGS. 15A-15B illustrate an application dependency display that is presented by selecting “Dependencies” under “Versions” from the expanded “Search and Maintenance” navigation bar.

The figures show “Immediate Dependencies” in FIG. 15A and identifies the dependent application (PeopleNet 4.1) in the first column, a relationship to the dependency application (e.g., calls the application), the name of the dependency application e.g., DB2 Connect 7.1 FP6), comments, and an action link (view, edit, delete). Scrolling down the display, “Immediate Dependents” are shown with the dependent application in the first column, a relationship, the dependent application, comments and an action link (view, edit delete).

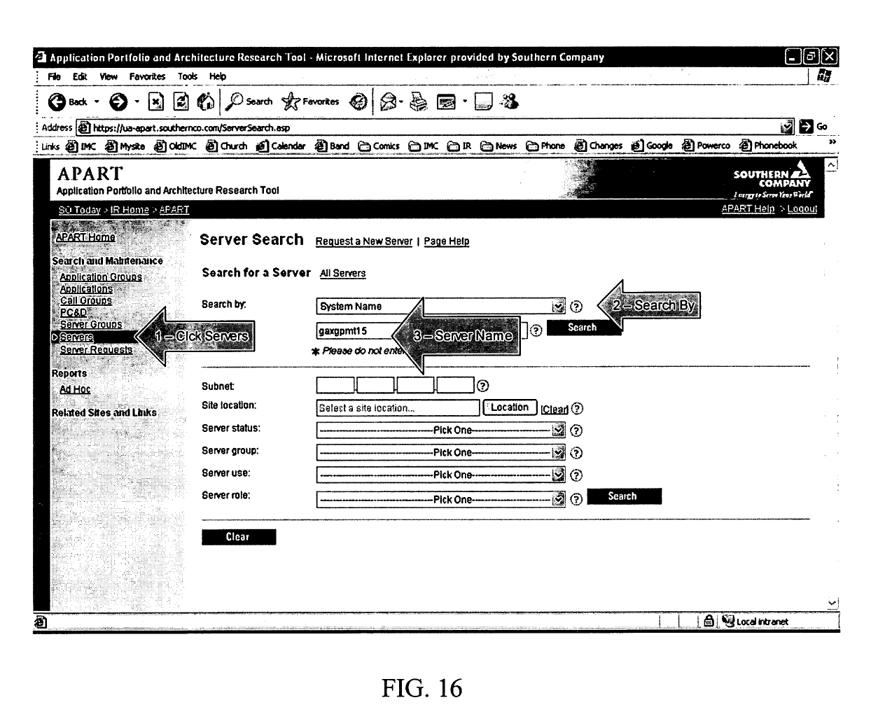

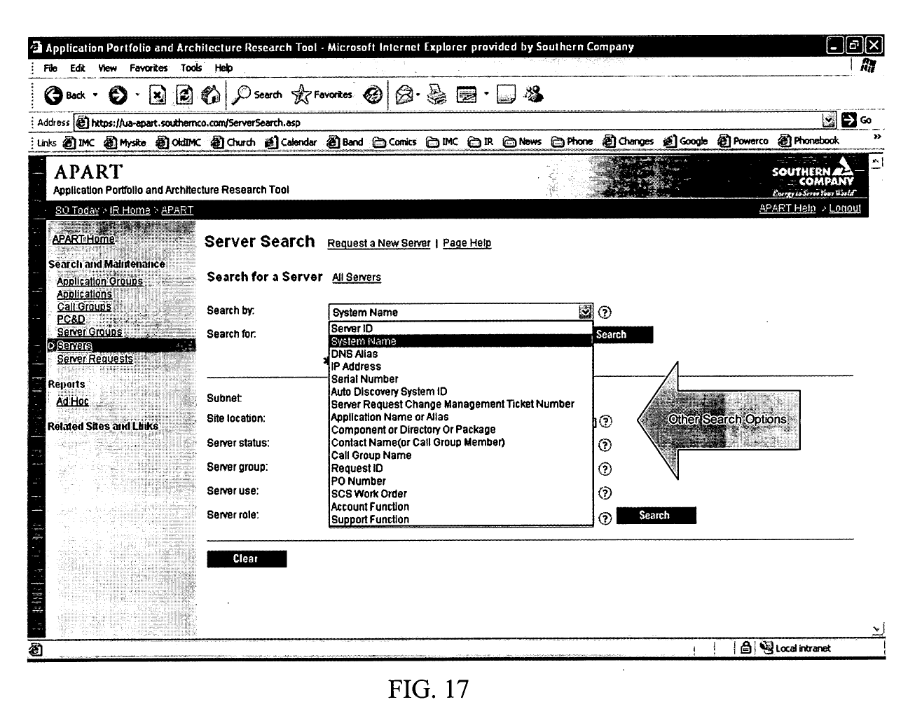

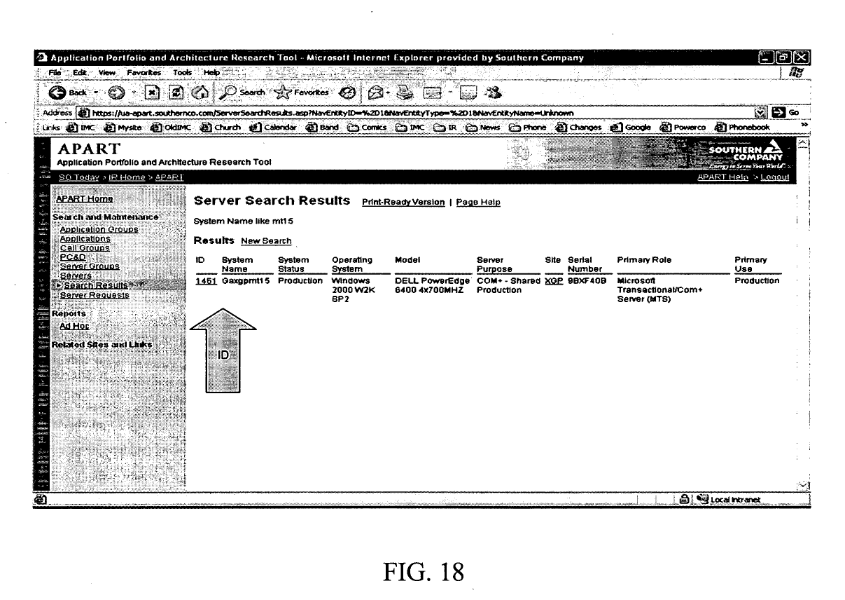

FIG. 16 illustrates a server search display that is generated by selecting “Servers” from the “Search and Maintenance” navigation bar of FIG. 2. A server search window is displayed to the right of the navigation bar. The server search can be based on system name with the server name entered into the search query window. As illustrated in FIG. 17, the server search can be based on server ID, system name, DNS alias, IP address, serial number, auto discovery system ID, or other search options. Server search results for the search query of FIG. 16 are displayed in FIG. 18. The results display shows server ID, system name, system status (e.g., production), operating system, server model, server function, site (location), server serial number, primary role and primary use.

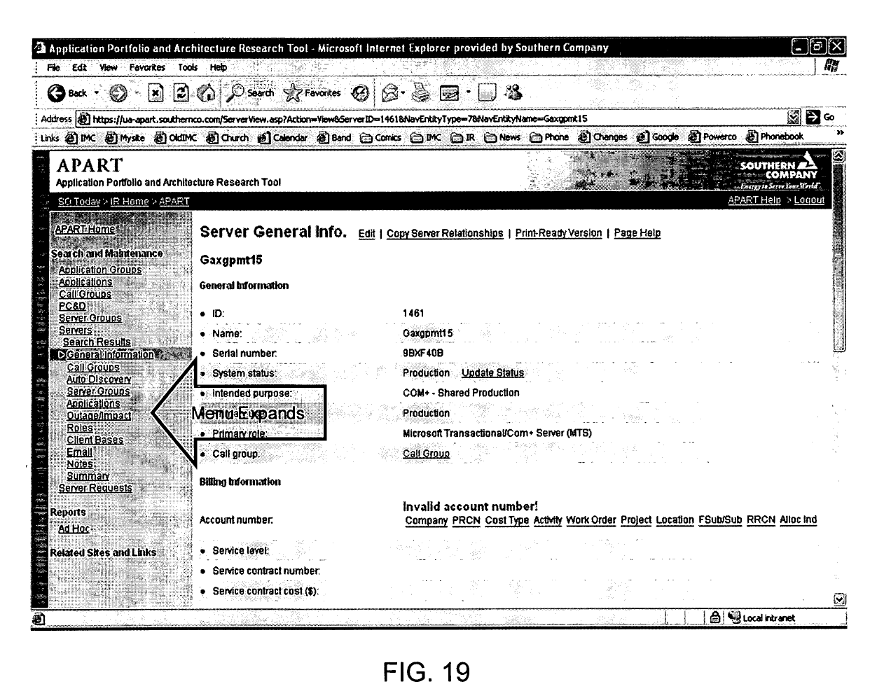

Additional information pertaining to the server search results displayed in FIG. 18 can be obtained by selecting “Search Results” in the “Search and Maintenance” navigation bar. As illustrated in FIG. 19, this selection provides links for general information, call groups, auto discovery, server groups, applications, outage/impact, roles, client bases, email, notes and summary. FIG. 19 also illustrates a server general information display for the server results of FIG. 18. It includes general information previously shown in FIG. 18 along with billing information.

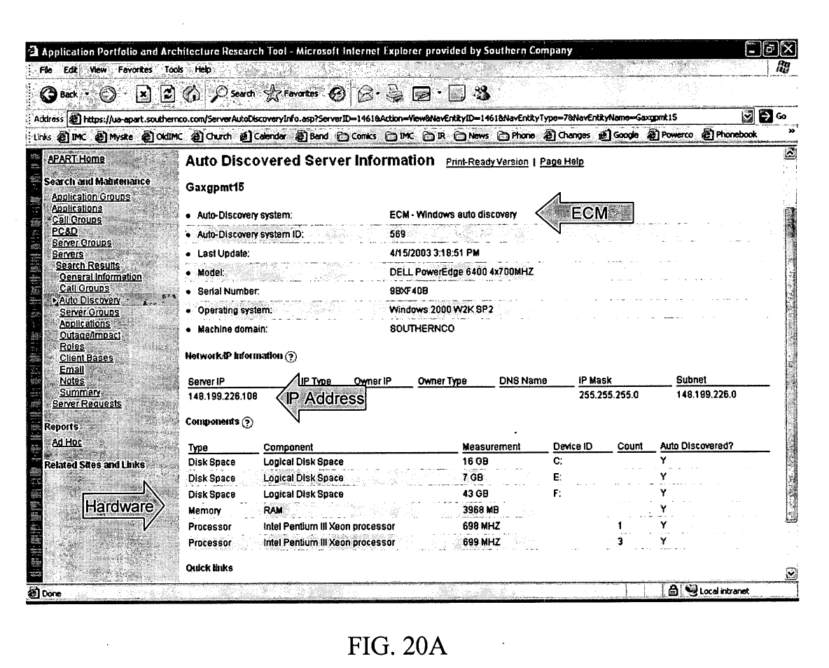

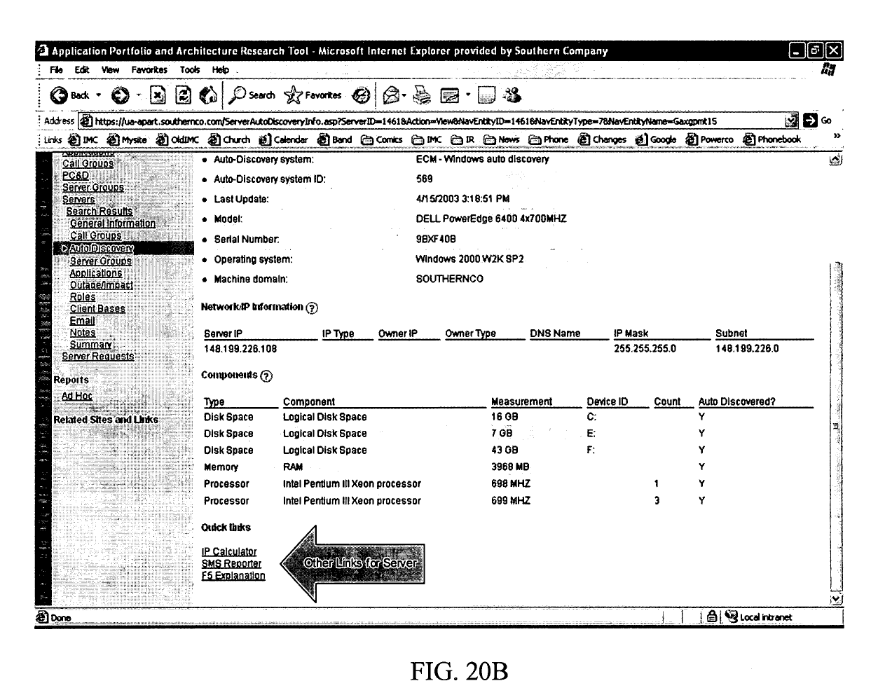

FIGS. 20A-20B illustrate an auto discovered server information display that is obtained by selecting the auto discovery link under “Search Results” in the “Search and Maintenance” navigation bar. This display is populated with data by the application process and also by such auto discovery applications as SMS, ECM and Asset Insight. Auto-discovery is one of the key technologies that enables management systems to be quickly customized to the environments that they are intended to manage. Most existing management systems have focused on discovery of hosts, servers, and network elements in isolation using auto-discovery techniques and do not determine relationships among such devices.

As shown in FIGS. 20A-20B, auto discovered server information includes information on the server and auto discovery system, network/IP information and component information. The information displayed includes the auto discovery system (e.g., ECM), the server model number, serial number and operating system. The network/IP information includes the server IP address, IP type, owner IP, DNS name, the IP mask and IP subnet. The components information includes the component type (e.g., disk space), the component name, a measurement value, a device ID, a count of units and whether or not the component is self-discovered. Scrolling down the auto discovered server information display, quick links to other server information are available. For example, the quick links could include an IP calculator or a SMS Reporter among the possible choices.

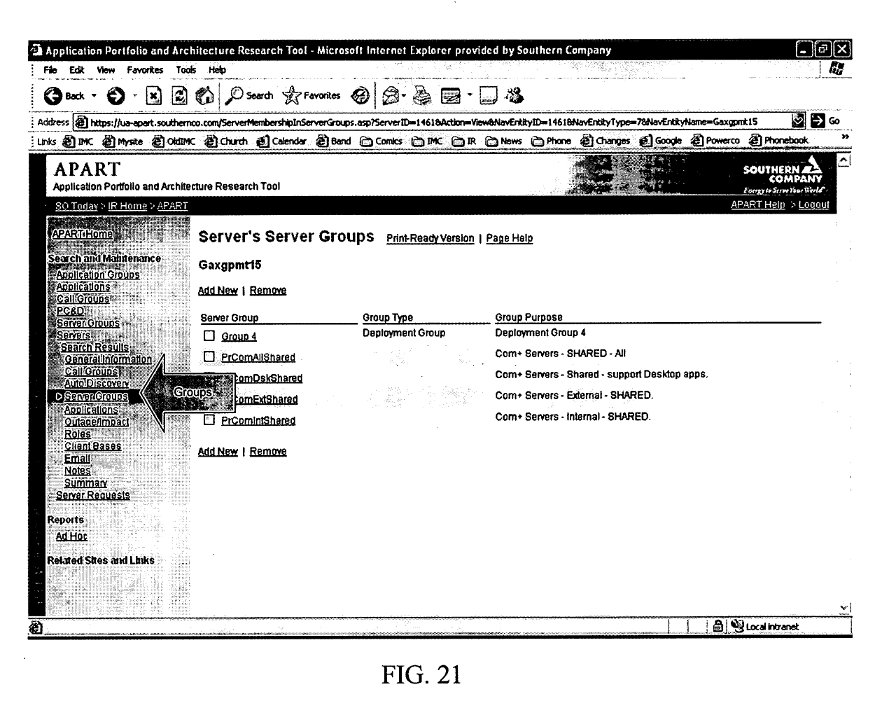

FIG. 21 illustrates a server search server groups display that is obtained by selecting the server groups link under “Search Results” in the “Search and Maintenance” navigation bar. The information shown includes the server group name, the group type and the group purpose for each server group associated with the specific server.

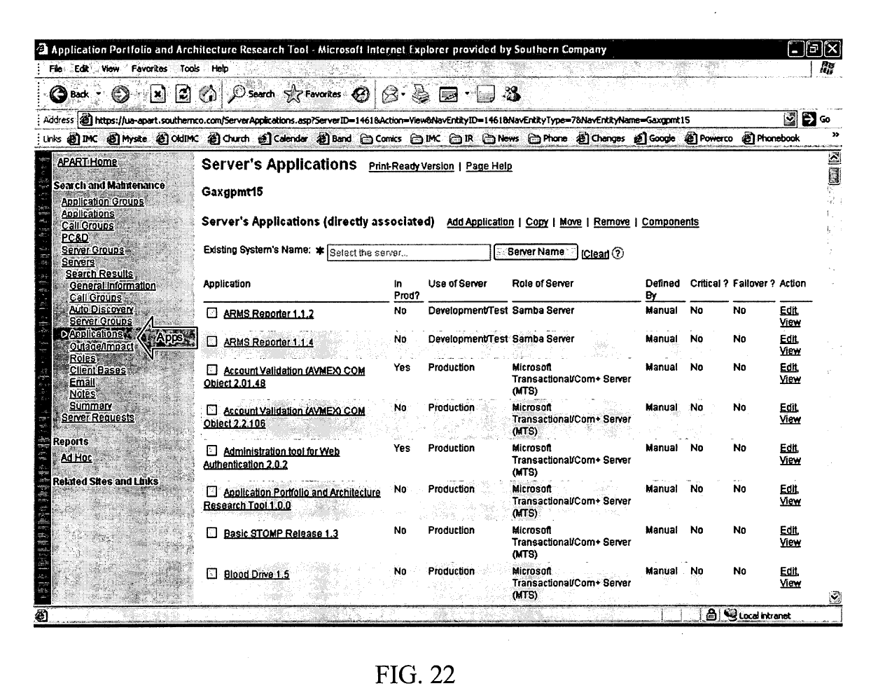

FIG. 22 illustrates a server search applications display that is obtained by selecting the applications link under “Search Results” in the “Search and Maintenance” navigation bar. The figure identifies the server name at the top of the display and provides information on the applications directly associated with the server. This information includes the application name, whether or not the application is in production, the server use, the serve role, how the application is defined, whether the application is critical and an action link (edit, view).

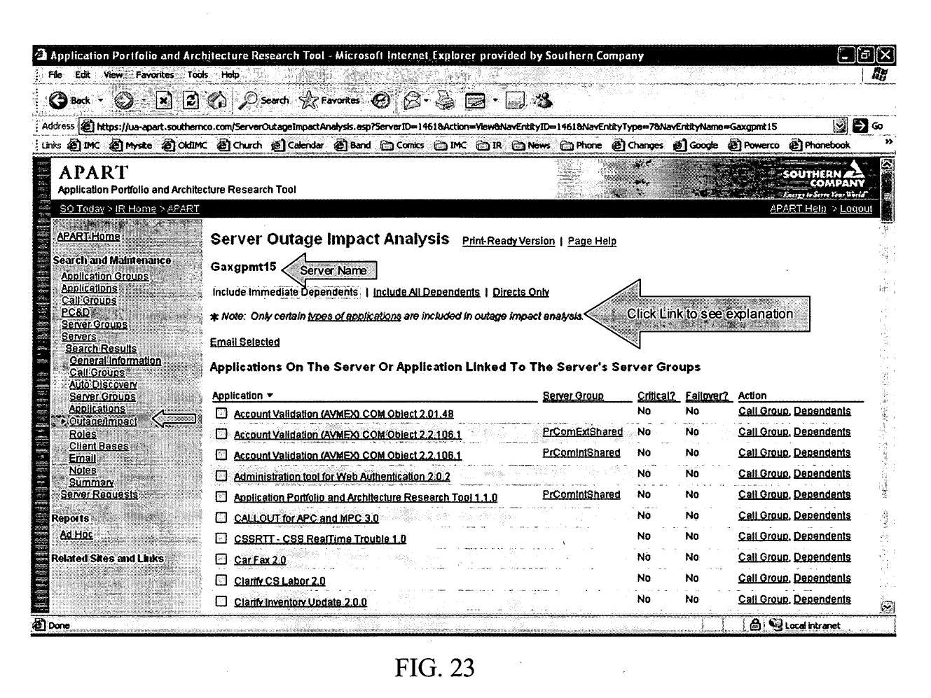

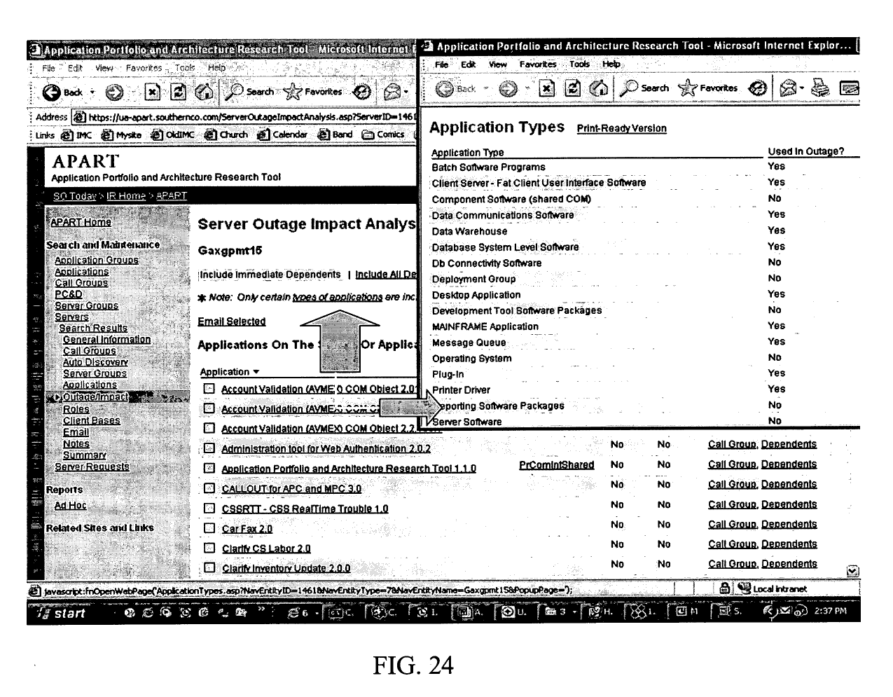

FIG. 23 illustrates a server search outage impact analysis display that is obtained by selecting the outage/impact link under “Search Results” in the “Search and Maintenance” navigation bar. For the specific server, the figure displays the applications on the server or linked to the server's server group. The information displayed includes application names, server groups, whether the application is critical, and an action link (call group, dependents). A type of application link displayed in FIG. 23 results in the window shown in FIG. 24 being displayed. The window identifies the application types and whether or not they are used in server outage.

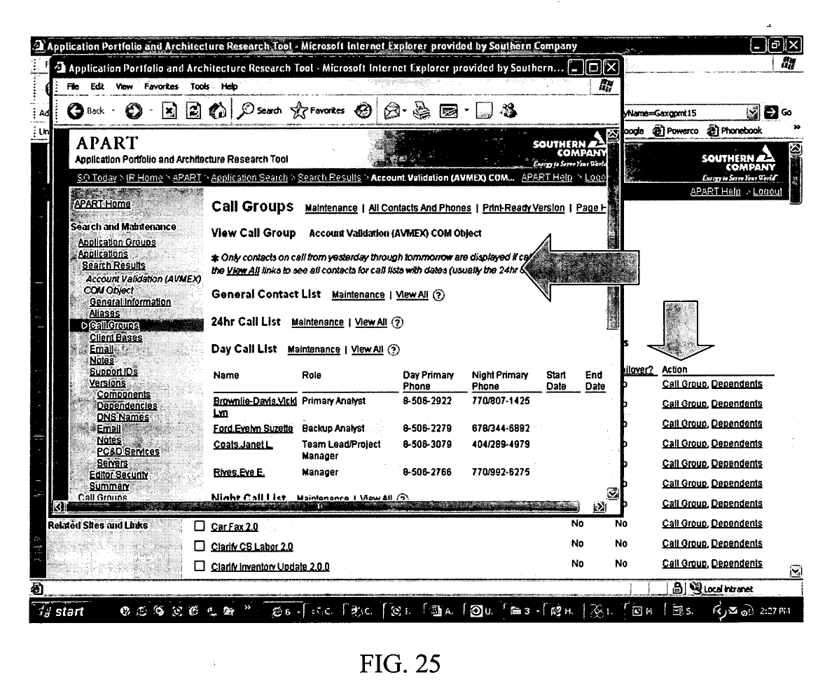

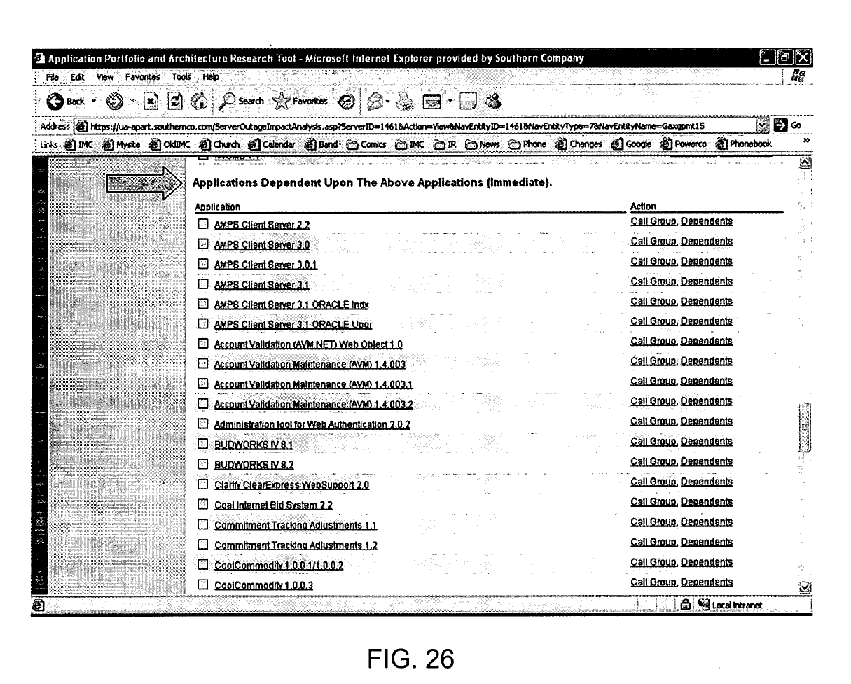

FIGS. 25-26 relate to the action links (call groups, dependents) shown in FIG. 23. Selecting a call group link for a specific application depicted in FIG. 23 results in the call groups window shown in FIG. 25. Selecting a dependents link for a specific application depicted in FIG. 23 results in the dependency window shown in FIG. 26. This window displays the application that are dependent on the specific application selected.

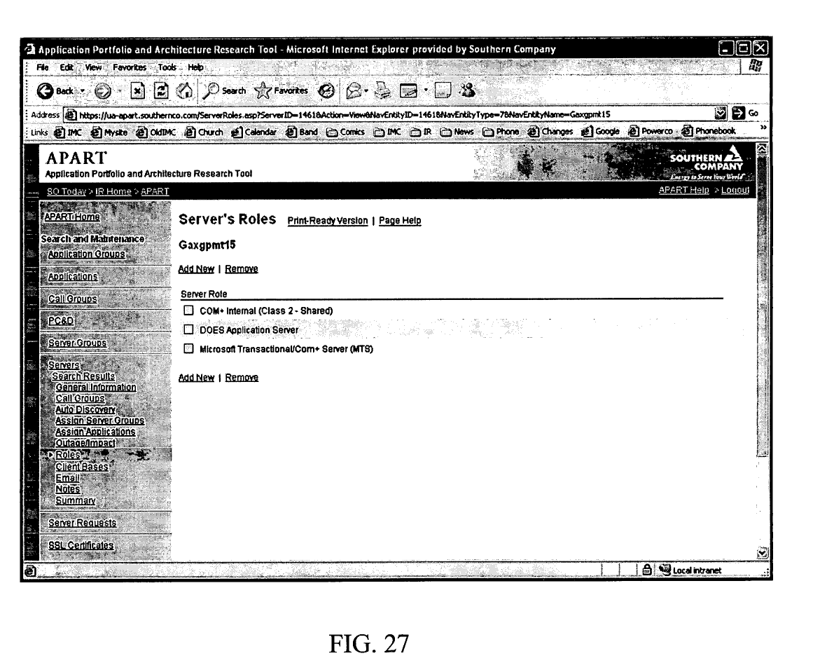

FIG. 27 illustrates a server search roles display that is obtained by selecting the roles link under “Search Results” in the “Search and Maintenance” navigation bar. The roles for the specific server are displayed. For example, a server role could be as a transactional/COM+ server providing COM+ transaction services.

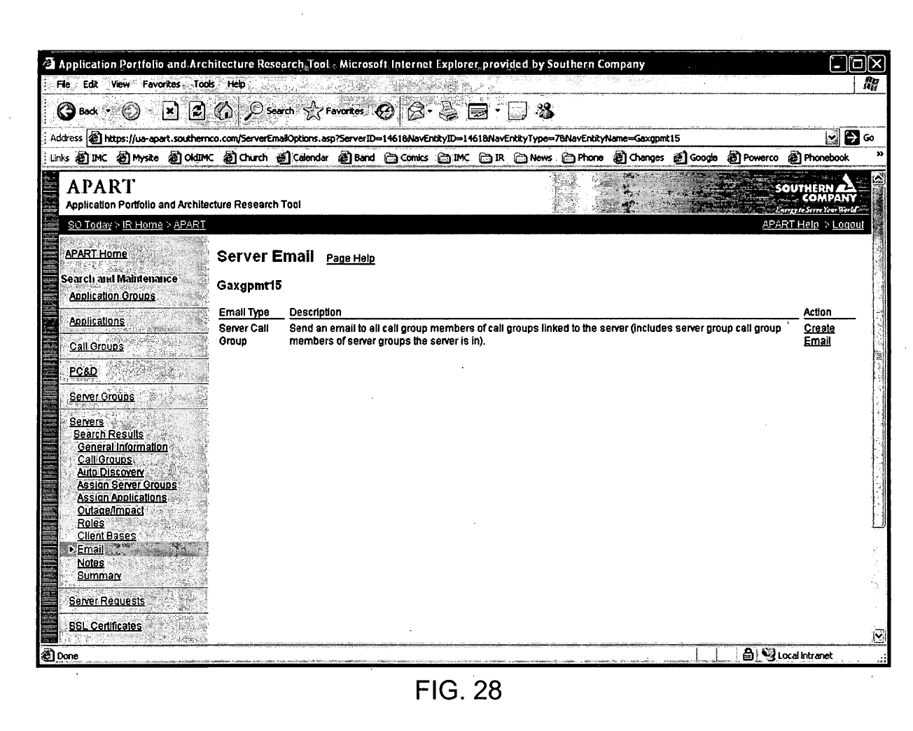

FIG. 28 illustrates a server search email display that is obtained by selecting the email link under “Search Results” in the “Search and Maintenance” navigation bar. The display includes the email type and a description of the email to be sent to the call group.

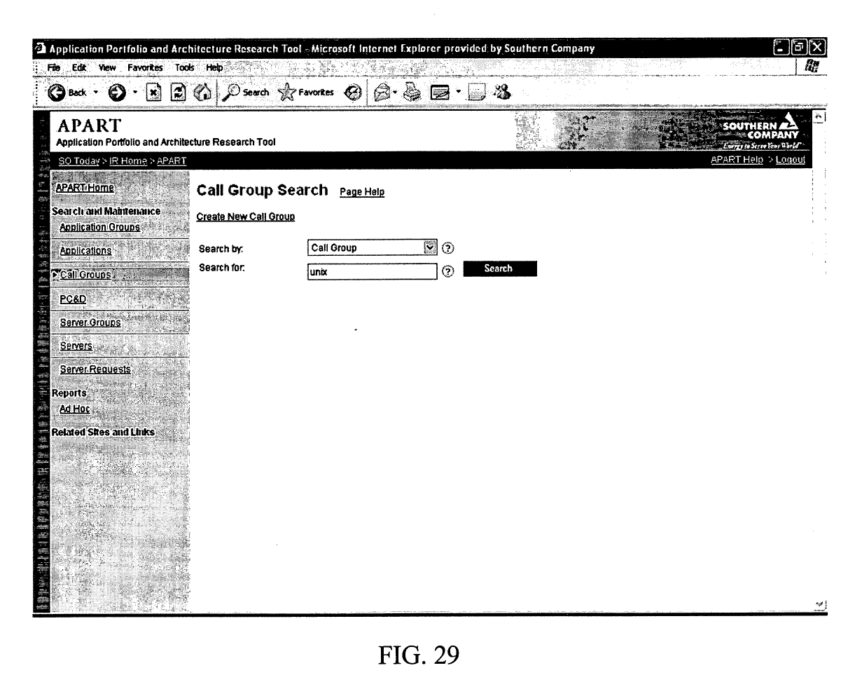

FIG. 29 illustrates a contacts and call group search window that is obtained by selecting “Call Groups” in the “Search and Maintenance” navigation bar. The user enters a specific query such as “UNIX” to retrieve call group information for that application.

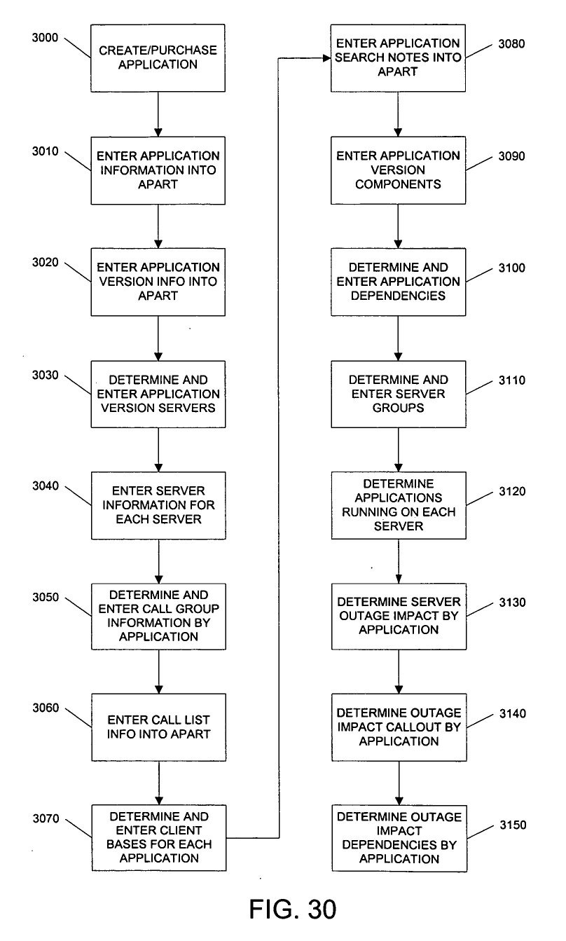

FIG. 30 illustrates the high level processing logic for the APART system of the present invention. The first logic block 3000 in the flowchart represents the development or purchase of an application that is to be tracked, monitored and maintained by APART. As indicated in logic block 3010, application information is entered into APART. The application information includes, but is not limited to, the items shown in FIG. 5, such as application ID, application name and acronym, application type, application description, frequency of use, business impact, recovery priority, the developer, and the support organization. Application version information is entered into APART as indicated in logic block 3020. As shown in FIG. 6, this information includes, but is not limited to, version number, version description, tracking number, change management ticket number, status of the version, whether the version is in production, and the server run location.

The application version servers are determined and entered into APART as indicated in logic block 3030. For the specific application, this information includes, but is not limited to, version, the server name, server group, server use and server role as shown in FIG. 8. Server information needs to be entered for each server included in the APART system. This step is indicated by logic block 3040. However, the step does not have to be performed in the sequence of steps shown in FIG. 30. As shown in FIG. 9, server information includes, but is not limited to, server ID, server name, server status, intended purpose, primary use, primary role and call group.

Call group information is entered into APART by application as indicated in logic block 3050. As shown in FIG. 10, call group information includes, but is not limited to, a general contact list, a 24 hour call list, a day call list and a night call list. Call list information is entered for each individual providing call group support as indicated in logic block 3060. Exemplary call list information is shown in FIG. 11.

For each application in use in the organization, there is a client base defined for the application. This client base is determine and entered into APART as indicated in logic block 3070. Client base information could include, although it is not limited to, business unit and operating company within the organization that uses the application. FIG. 12 illustrates an exemplary client bases display.

Application notes are entered into APART as indicated in logic block 3080 and includes information such as the type of note, the note itself (e.g., location of project documentation), and a link to a folder containing documentation or other information regarding the application. FIG. 13 provides an example of an application notes display.

Components of an application version are entered into APART as indicated in logic block 3090. Each executable and COM object owned by the application version should be entered as components. FIG. 14 provides an example of an application version components display. Not only are the individual components of an application added, but also dependencies on other applications. The process step of determining and entering application dependencies is indicated in logic block 3100. FIGS. 15A-15B provide an example of dependency relationships for application components. As shown, the information displayed can include the dependent application name, its immediate dependency applications/components, and the relationship to the immediate dependency applications/components.

As indicated in logic block 3110, server group information is determined for each server and entered into APART. This information includes server group name, group type and group purpose for each server. FIG. 21 provides an example of a server groups display for a specific server. The applications running on each server are determined by APART as indicated in logic block 3120. FIG. 12 provides an example of a display showing the applications running on a specific server. Included in the display are the application names, production status, server use and server role. Other information for each application running on the server can also be displayed.

As indicated in logic block 3130, the impact of a server's outage by application is determined by APART. For a specific server, APART provides a list of application running on the server, the server group (if defined), whether the applications are critical to operation. FIG. 23 provides an example of a server outage impact analysis display. The outage impact callout by application is determined by APART as indicated in logic block 3140. FIG. 25 provides an exemplary display. Outage impact dependencies by application are determined by APART as indicated in logic block 3150. FIG. 26 illustrates an exemplary display.

The application portfolio research tool for managing and coordinating information and changes to the IT infrastructure of the present invention has been described as a computer implemented process. It is important to note, however, that those skilled in the art will appreciate that the mechanisms of the present invention are capable of being distributed as a program product in a variety of forms, and that the present invention applies regardless of the particular type of signal bearing media utilized to carry out the distribution. Examples of signal bearing media include, without limitation, recordable-type media such as diskettes or CD ROMs, and transmission type media such as analog or digital communications links.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the spirit and scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

1. A method for automatically managing and coordinating information and changes relating to an information technology infrastructure, wherein the information and changes are stored in an application portfolio database, comprising the steps of:
determining and storing information for a plurality of applications and a plurality of servers, the application information including application version identification and status for each application, the server information including server identification, status and a call group for each server;
determining and storing information for a plurality of call groups, with each call group defining a call list of contacts;
determining and storing information for a plurality of components for each version of an application;
determining and storing a plurality of application dependencies for each application;
identifying a plurality of applications associated with each server; and
determining an impact analysis in the event of server failure for each application running on each server, wherein an impact analysis display provides a link to application dependencies and the call group associated with the server.

2. The method for automatically managing and coordinating information and changes of claim 1 wherein the application information further includes an application description, a business impact, a recovery priority and a support organization responsible for maintaining the application.

3. The method for automatically managing and coordinating information and changes of claim 1 wherein the application version information further includes a version number, a version description, a tracking number, a change management ticket number, a production status and a server run location.

4. The method for automatically managing and coordinating information and changes of claim 1 wherein the server information further includes a server name, a server group, a server use and a server role.

5. The method for automatically managing and coordinating information and changes of claim 1 wherein the call group for each server includes a contact list of individuals to call in the event of the server's failure.

6. The method for automatically managing and coordinating information and changes of claim 1 wherein the plurality of components for each application includes each executable file associated with the application.

7. The method for automatically managing and coordinating information and changes of claim 6 wherein the plurality of components for each application further includes a plurality of objects owned by the application.

8. The method for automatically managing and coordinating information and changes of claim 1 wherein the step of determining a plurality of application dependencies for each application includes determining a relationship between each application and each of the application dependencies.

9. The method for automatically managing and coordinating information and changes of claim 4 wherein the server information further includes a server group type and a group purpose for each server.

10. The method for automatically managing and coordinating information and changes of claim 1 wherein the step of determining the impact analysis in the event of server failure includes identifying a recovery criticality factor for each application running on the server.

11. The method for automatically managing and coordinating information and changes of claim 1 wherein the step of determining the impact analysis in the event of server failure further includes displaying a plurality of applications that are dependent on a recovery critical application.

12. The method for automatically managing and coordinating information and changes of claim 1 wherein the step of determining the impact analysis in the event of server failure further includes displaying a call group including a contact list of individuals to call in the event of the server's failure.

13. The method for automatically managing and coordinating information and changes of claim 1 wherein the step of determining server information comprises interfacing to an auto-discovery system to import server information, network information, and component information into the application portfolio database automatically.

14. The method for automatically managing and coordinating information and changes of claim 1 further comprising the step of determining a client base for each application, wherein each client represents a business unit within an organization.

15. The method for automatically managing and coordinating information and changes of claim 1 further comprising the step of adding an application note for each application, wherein the application note includes a location for the application's documentation.

16. A computer program product for automatically managing and coordinating information and changes relating to an information technology infrastructure, wherein the information and changes are stored in an application portfolio database, the computer program product comprising computer readable medium having computer readable code embedded therein, the computer readable medium comprising:
program instructions that determine and store information for a plurality of applications and a plurality of servers, the application information including application version identification and status for each application, the server information including server identification, status and a call group for each server;
program instructions that determine and store information for a plurality of call groups, with each call group defining a call list of contacts;
program instructions that determine and store information for a plurality of components for each version of an application;
program instructions that determine and store a plurality of application dependencies for each application;
program instructions that identify a plurality of applications associated with each server; and
program instructions that determine an impact analysis in the event of server failure for each application running on each server, wherein an impact analysis display provides a link to application dependencies and the call group associated with the server.

17. The computer program product for automatically managing and coordinating information and changes of claim 16 wherein the application information further includes an application description, a business impact, a recovery priority and a support organization responsible for maintaining the application.

18. The computer program product for automatically managing and coordinating information and changes of claim 16 wherein the application version information further includes a version number, a version description, a tracking number, a change management ticket number, a production status and a server run location.

19. The computer program product for automatically managing and coordinating information and changes of claim 16 wherein the server information further includes a server name, a server group, a server use and a server role.

20. The computer program product for automatically managing and coordinating information and changes of claim 16 wherein the call group for each server includes a contact list of individuals to call in the event of the server's failure.

21. The computer program product for automatically managing and coordinating information and changes of claim 16 wherein the plurality of components for each application includes each executable file associated with the application.

22. The computer program product for automatically managing and coordinating information and changes of claim 21 wherein the plurality of components for each application further includes a plurality of objects owned by the application.

23. The computer program product for automatically managing and coordinating information and changes of claim 16 wherein the program instructions that determine a plurality of application dependencies for each application include program instructions that determine a relationship between each application and each of the application dependencies.

24. The computer program product for automatically managing and coordinating information and changes of claim 19 wherein the server information further includes a server group type and a group purpose for each server.

25. The computer program product for automatically managing and coordinating information and changes of claim 16 wherein the program instructions that determine the impact analysis in the event of server failure includes program instructions that identify a recovery criticality factor for each application running on the server.

26. The computer program product for automatically managing and coordinating information and changes of claim 16 wherein the program instructions that determine the impact analysis in the event of server failure further include program instructions that display a plurality of applications that are dependent on a recovery critical application.

27. The computer program product for automatically managing and coordinating information and changes of claim 16 wherein the program instructions that determine the impact analysis in the event of server failure further include program instructions that display a call group including a contact list of individuals to call in the event of the server's failure.

28. The computer program product for automatically managing and coordinating information and changes of claim 16 wherein the program instructions that determine server information comprises program instructions that interface to an auto-discovery system to import server information, network information, and component information into the application portfolio database automatically.
